(19) United States
(12) Patent Application Publication
(10) Pub. No.: US 2023/0029279 A1
(43) Pub. Date: Jan. 26, 2023

(54) MOBILE MODULAR DWELLING SYSTEM

(71) Applicant: North American Glamping LLC, Southfield, MI (US)

(72) Inventor: Bradley Bruce BOTHAM, West Bloomfield, MI (US)

(21) Appl. No.: 17/403,359

(22) Filed: Aug. 16, 2021

Related U.S. Application Data
(63) Continuation-in-part of application No. 29/799,801, filed on Jul. 16, 2021.

(51) Int. Cl. E04B 1/348; E06B 3/46; E06B 9/24; E04D 13/03

(52) U.S. Cl. CPC E04B 1/34861; E04B 1/34869; E06B 3/4609; E06B 9/24; E04D 13/033; E04B 2001/34892; E06B 3/4654; E06B 2009/247; E04B 2001/0053

(57) ABSTRACT

A mobile modular dwelling system comprising a floor; a front semicircular sub-assembly secured to the floor, the front semicircular sub-assembly including a pane arrangement; and a rear polygonal sub-assembly also secured to the floor and to the front semicircular sub-assembly. In combination, the front and rear sub-assemblies provide a shelter in the face of prevailing wind and rain, regardless of the direction from which weather may originate, while offering an interior designer a wider latitude of furniture choices than does a semicircular footprint alone.

### REFERENCE TO RELATED APPLICATIONS

This application is a continuation-in-part of U.S. design application Ser. No. 29/799,801 filed Jul. 16, 2021, the disclosure of which is hereby incorporated in its entirety by reference herein.

### TECHNICAL FIELD

This disclosure relates to a portable, at least partially prefabricated modular dwelling system including a front sub-assembly with a sliding bowed panoramic translucent pane. At the rear of the front sub-assembly is a mating rear sub-assembly with a rectangular footprint.

### BACKGROUND

Spurred by emergence from the pandemic era, many are answering a call of the wild: back to nature. To answer that call, it would be desirable to provide a safe, weather-resistant system that offers comfortable accommodations that can readily be positioned in an attractive setting.

Cylindrical mobile housing structures are known. See, e.g., Lumipod by Lumiscene—www.lumi-pod.com. But climate change has wrought severe weather changes that can emerge without warning. Such weather changes can expose a remotely located infirm dwelling unit to strong winds which the structure must be built and supported to withstand. A relatively small circular footprint for a given volume of interior space may be insufficient to provide a reliable shelter.

Further, a circular footprint offers challenges to the interior designer. Most furniture is configured to cooperate with flat walls. The choices of furniture that fit when juxtaposed with circular walls are few and tend to be expensive.

### SUMMARY

Disclosed herein is a safe, weather-resistant modular dwelling system that offers comfortable accommodations and can readily be positioned and re-positioned in an attractive setting. The system offers a firm structure within volumetric constraints. A front semicircular sub-assembly is backed up by a rear, preferably quadrilateral sub-assembly. In combination, these sub-assemblies offer predictably safe resistance to and a firm platform in the face of prevailing wind and rain, regardless of the direction from which severe weather may come. Further, the quadrilateral footprint offers the interior designer a wider latitude of furniture choices than does a circular footprint.

The sub-assemblies preferably are conveniently situated in a potentially remote site of choice. Assembly implies ready conveyance of an assembled or un-assembled or partially assembled dwelling unit that can conveniently be transported to a chosen site and readily be re-located to subsequently chosen sites, as desired.

Ideally, the system houses an array of convenient utilities.

It is, therefore, an object of the present disclosure to provide to a portable, at least partially prefabricated dwelling system including a front sub-assembly with a sliding bowed panoramic pane made of transparent or translucent material that affords a wide range of view. At the rear of the front sub-assembly is a mating rear sub-assembly with a polygonal, preferably quadrilateral footprint that accommodates a variety of convenience and utility features.

After moving assembled or unassembled components to a desired site, a user then has access to a retreat with comfortable facilities. Thus, an enhanced camping-like experience is created.

In some embodiments, an assembled system includes a floor that is secured to an underlying foundation, for example a concrete pad. In other embodiments, the system is supported by in-ground or above-ground posts. The floor has a footprint with a semicircular section that is appended to the polygonal, preferably rectangular, section. Rising from the footprint is a wall structure that supports a roof. The system is preferably mounted on posts that are seated on or in the ground. Such posts can be variously sized above the ground to support a generally horizontal floor, regardless of the topography of underlying terrain. Especially when seated above ground, the posts present minimal adverse environmental impact.

Within the interior space that lies in the front and rear sub-assemblies, various utilities are housed. They include a bathroom, closet, a bedroom, and a kitchenette. Access to the system is provided by a side door. This allows any debris brought in underfoot from the outdoors to be contained away from a bedroom and other areas in the system.

The panoramic, repositionable, bowed transparent pane arrangement preferably extends from the floor to or short of the ceiling. This arrangement affords a wide-angle view of the environs. If desired, the pane arrangement can be positioned in an opened or partly opened position. This feature allows a sleeping area to serve as a covered outdoor space that emulates an outdoor camping environment.

Such a dwelling system is relatively uncomplicated in its transportability, ease of assembly and use, while offering an outdoor experience to those who wish comfortably to get away from it all.

In summary, several embodiments of the disclosed system include some or all of these features:
1. Curved front walls and planar rear walls
2. Access entry way
3. Bowed sliding translucent or transparent panes
4. Window and wall coverings
5. Bedroom
6. Kitchenette
7. Washroom and commode
8. Closet
9. Utility room
10. Sauna or hot tub

Preferably, the bowed sliding panes are in the front sub-assembly. In one embodiment, the panes are supported by window frames that extend vertically between a floor-mounted track and a ceiling-mounted track and slide horizontally. This enables the interior front spaces to serve as an outdoor space if desired. When closed, the panes afford protection from an adverse outdoor environment while still allowing the occupant(s) to commune with nature.

Various embodiments of the disclosed dwelling system are differently sized. Thus, a bare-bones hotel accommodation or a larger family-oriented experience are offered.

### BRIEF DESCRIPTION OF THE DRAWINGS

Preferred embodiments of the disclosure are outlined by way of example in the following description with reference to the attached drawings. In these attached drawings, identical or identically functioning components and elements are labeled with identical reference numbers and characters.

FIG. 1 is a front isometric view of a mobile dwelling system with bowed front panes in a closed position;

FIG. 2 is a left isometric view thereof;

FIG. 3 is a right isometric view thereof;

FIG. 4 is a top isometric view thereof;

FIG. 5 is a bottom isometric view thereof;

FIG. 6 is a back isometric view thereof;

FIG. 7 is a front isometric view of the mobile dwelling system with bowed front panes in an open position;

FIG. 8 is a left isometric view thereof;

FIG. 9 is a right isometric view thereof; and

FIG. 10 is a top isometric view thereof;

FIG. 11 is a quartering top left side perspective view of a frame with outer surfaces removed;

FIG. 12 is a quartering left bottom perspective view thereof; and

FIG. 13 is a plan view thereof with the roof removed.

### DETAILED DESCRIPTION

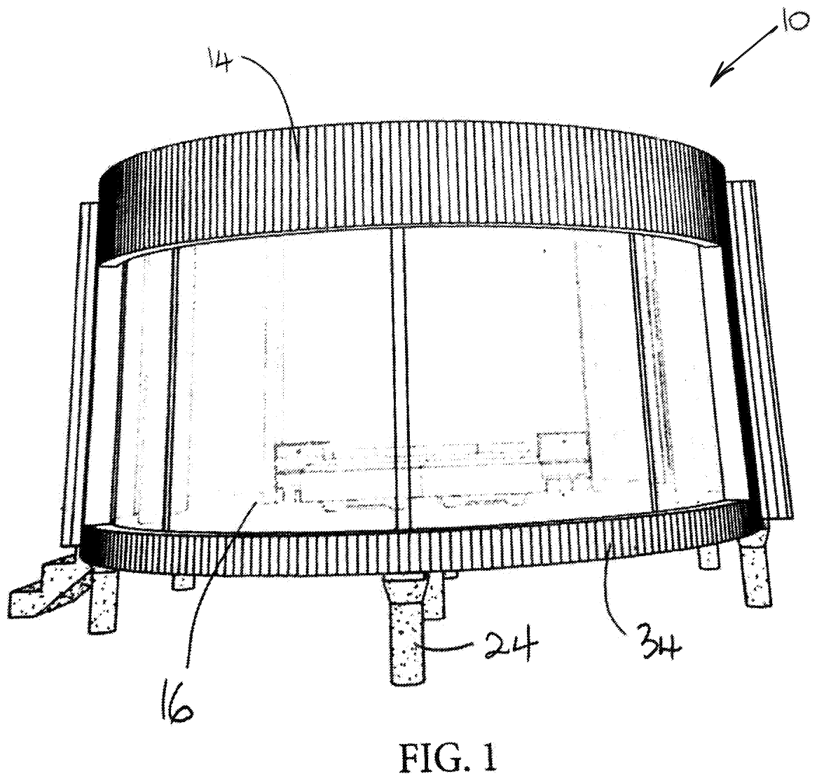

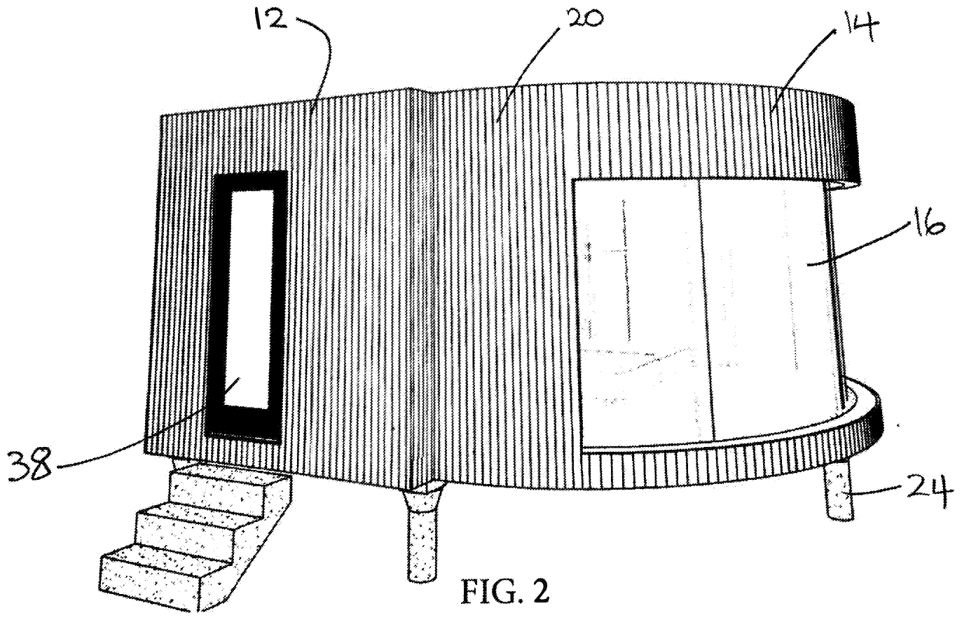

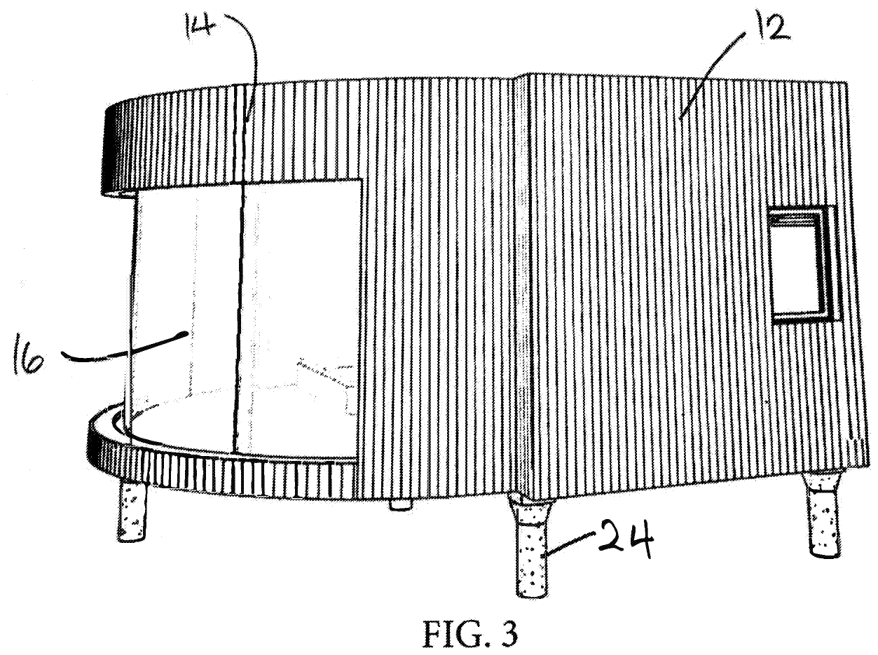

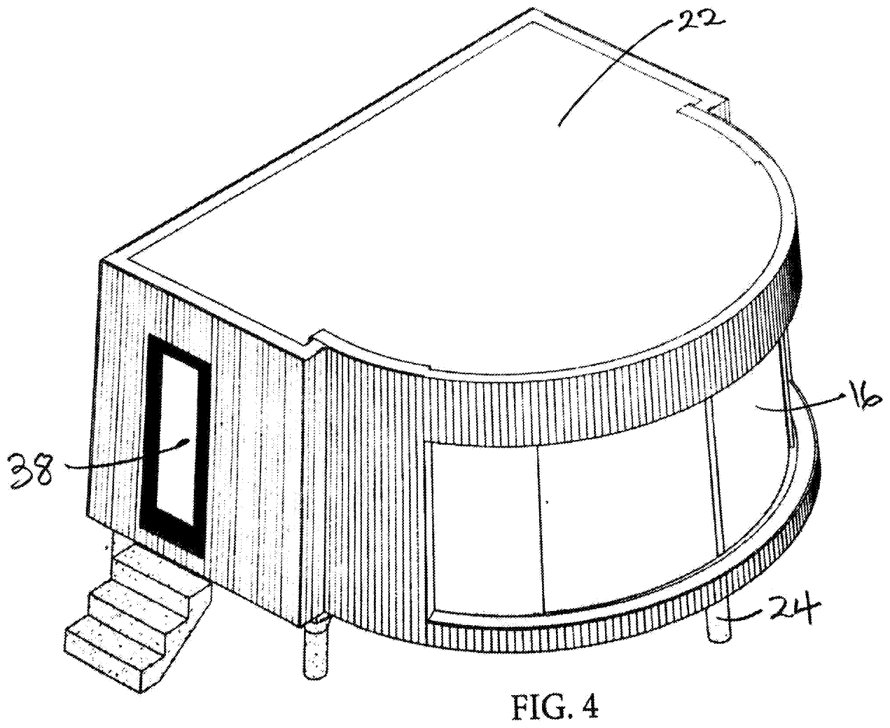

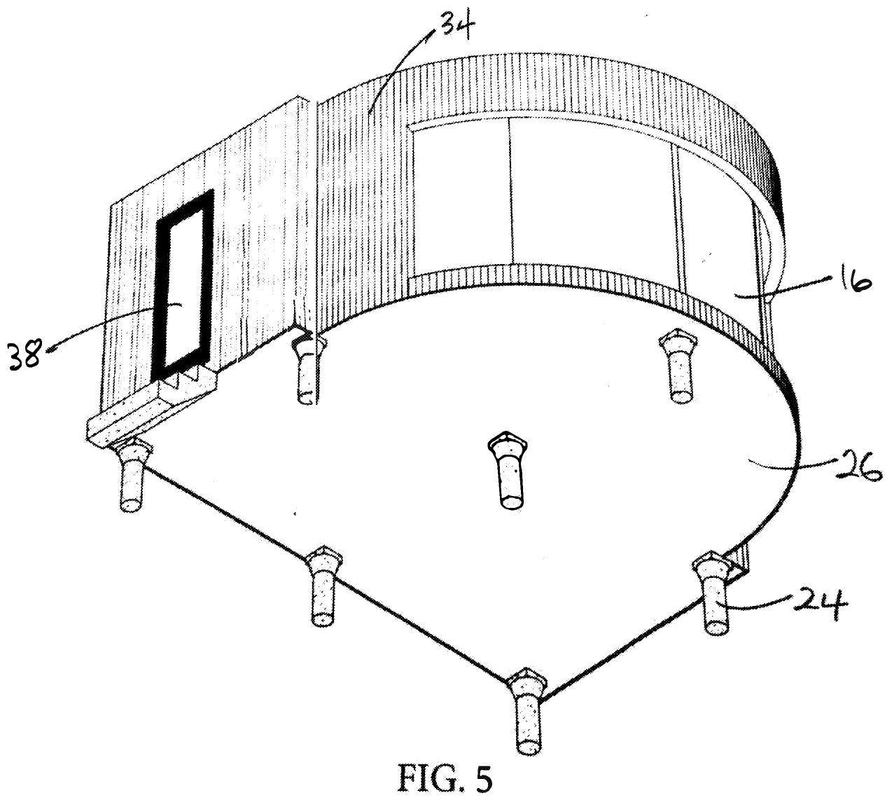

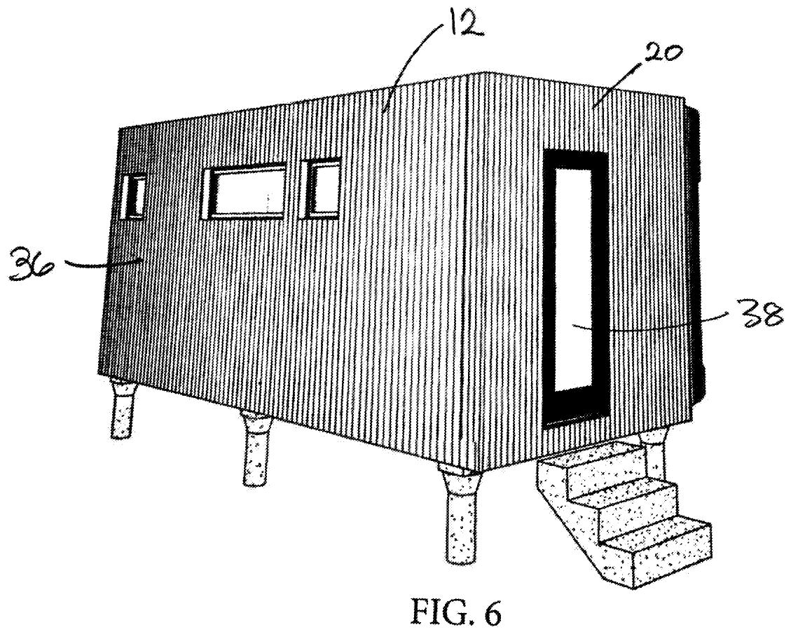

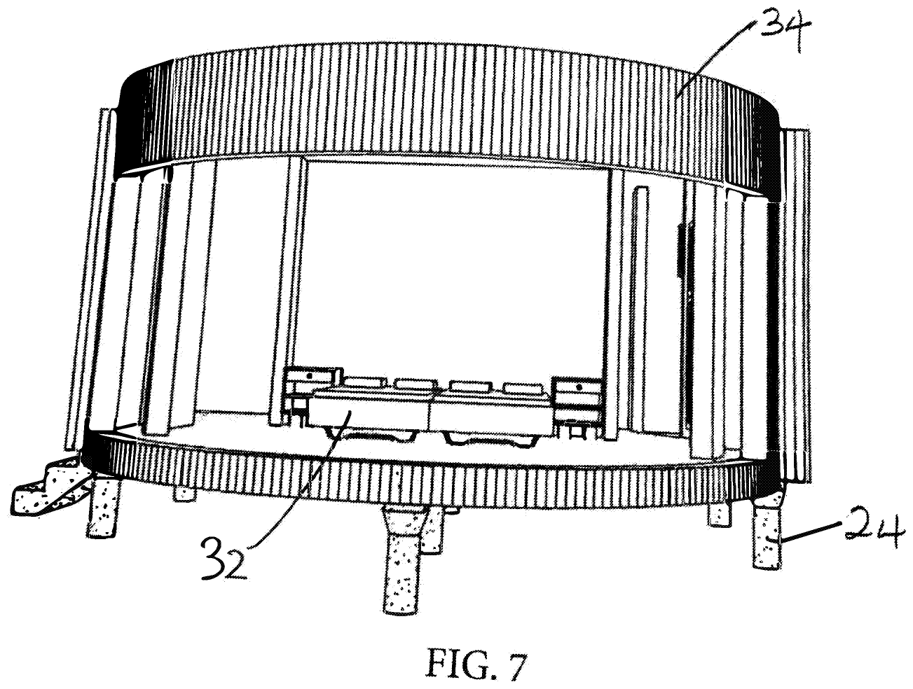

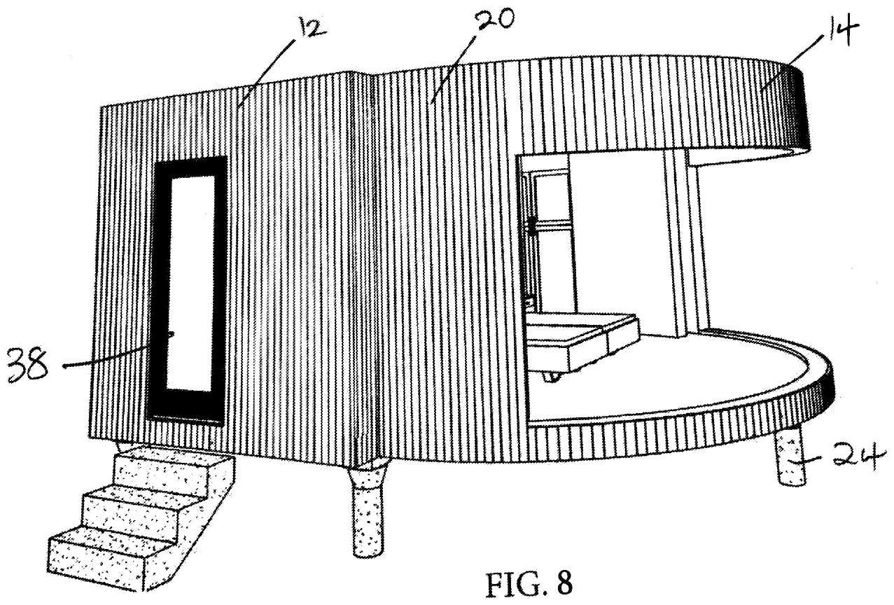

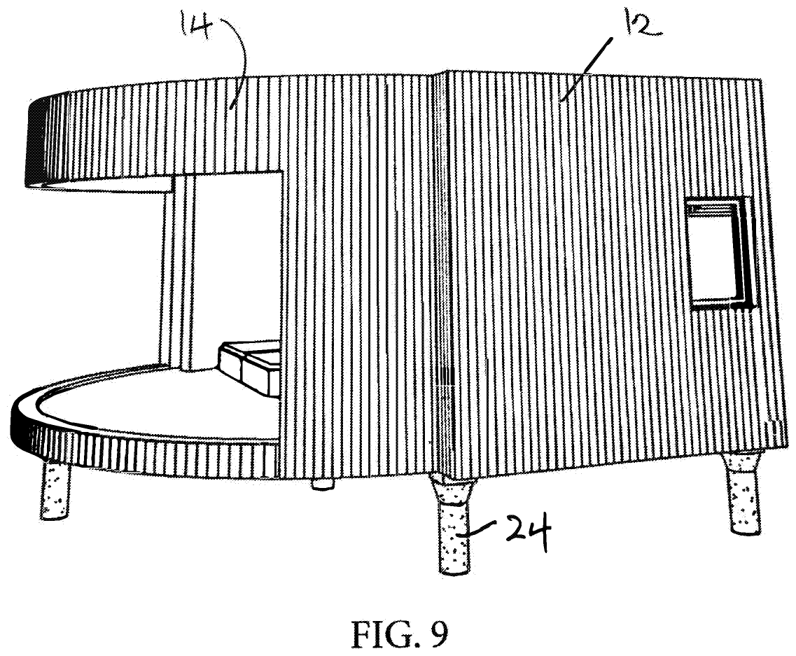

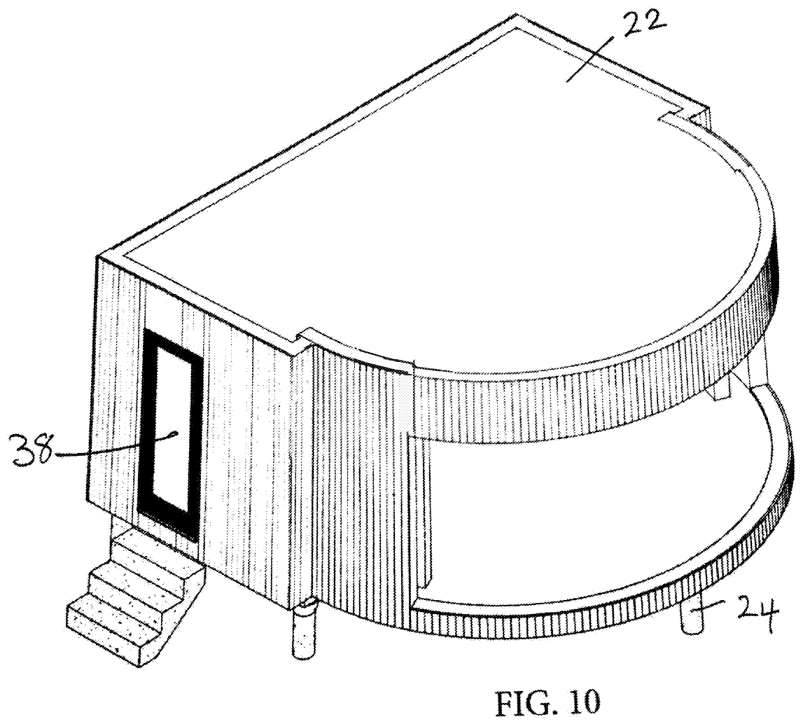

FIGS. 1-6 are views of a mobile dwelling system 10 that lies on a foundation or floor 26. The foundation may be a concrete-like pad or a post system to which the floor is secured. The system 10 has a rear sub-assembly 12 with a polygonal footprint and a front sub-assembly 14 with bowed footprint defined in part by panes 16 in a closed position. FIGS. 7-10 are corresponding views in which the panes 16 are open.

An object of the present disclosure to provide to a mobile, portable, at least partially prefabricated dwelling system 10 in which there are one or more sliding bowed panoramic panes 16 made of transparent or translucent material that affords a wide range of view. At the rear of the front sub-assembly 14, the mating rear sub-assembly 12 has a polygonal, preferably rectangular footprint that accommodates a variety of convenience and utility features.

After moving assembled or unassembled sub-assemblies or partially assembled sub-assemblies to a desired site, a user then has access to a retreat with comfortable utilities. Thus, an enhanced camping-like experience is created.

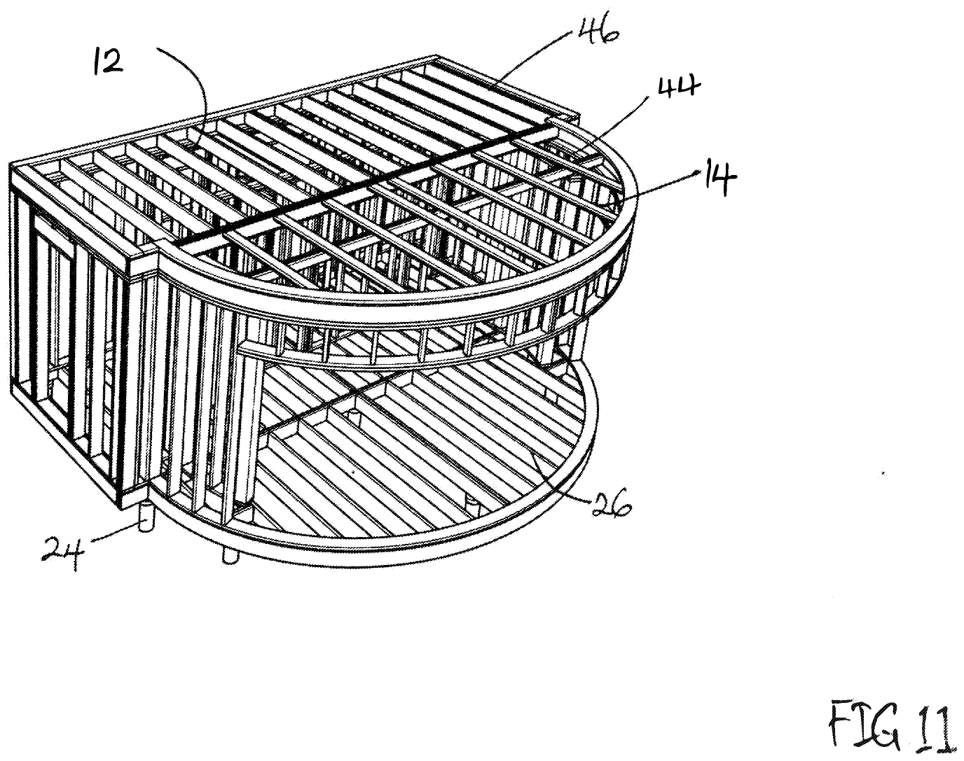

In some embodiments, an assembled system 10 has a footprint with a semicircular or oval or elliptical front sub-assembly 14 that is appended to a polygonal, preferably rectangular, rear sub-assembly 12 (see FIGS. 11-13). Rising from the footprint is a wall structure 20 that supports a roof 22. In some embodiments the roof 22 may include one or more skylights.

The system 10 has a floor 26 that in some embodiments is placed upon for example a concrete foundation. Optionally, the floor is mounted on posts 24 that are seated on or in the ground. Such posts 24 can be variously sized above the ground to support a generally horizontal floor 26, regardless of the topography of underlying terrain. Especially when positioned above ground, the posts 24 present minimal adverse environmental impact.

Within the interior space that lies in the rear and front sub-assemblies 12, 14, various utilities are housed. They include a bathroom 28, a closet 30, and a bedroom 32. A panoramic, repositionable, bowed transparent pane arrangement 16 preferably extends upwardly from the floor 26 to or towards the ceiling 44. This arrangement 16 affords a wide-angle view of the environs. If desired, the pane arrangement 16 can be positioned in an opened or partly opened position. This feature allows a sleeping area 32 to serve as a covered outdoor space that emulates an outdoor camping environment.

Such a dwelling system 10 is relatively uncomplicated in its transportability, ease of assembly and use, while offering an outdoor experience to those who wish comfortably to get away from it all. If desired, the system 10 can be transported to a site of interest in one piece, or in sub-assemblies that are united in situ.

In summary, several embodiments of the disclosed system 10 include some or all of these features under one roof 22:
1. curved front walls 34 and planar rear walls 20
2. access entry way 38
3. bowed sliding translucent or transparent pane arrangements 16
4. window and wall coverings 40
5. bedroom 32
6. washroom and commode 42.

As an initial step, utilities such as water, electricity, telephone and/or gas lines are provided to an installation site.

In preparation for connection to such utilities, the front and rear sub-assemblies 12, 14 of the mobile dwelling system 10 are transported from a manufacturing facility to the site of interest in an assembled or unassembled or partially assembled state. If unassembled, assembly occurs in situ. Assembly is enabled by various connection means, including adhesives, nuts, and bolts, and/or tongue and groove features.

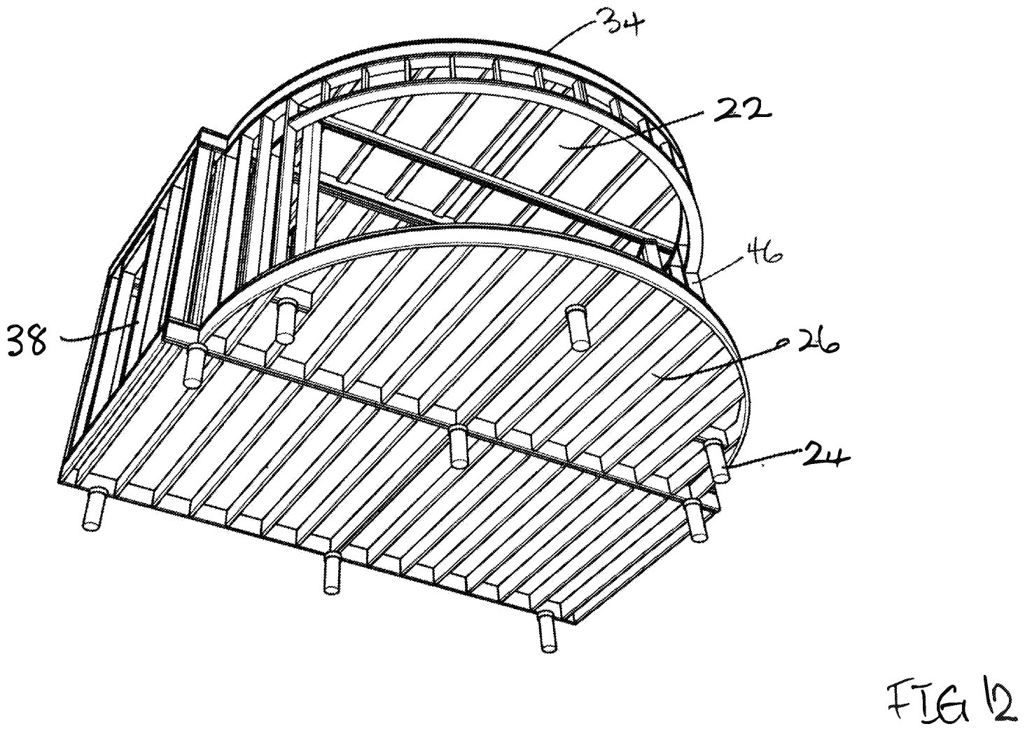

For ease of reference, the mobile dwelling system 10 can be considered in its pre-enhancement stages to be a shell 46 (FIGS. 11-12). This shell 46 serves as a support for later installed components and features (further discussed later). In some cases, the shell 46 is placed on for example a concrete pad. In other cases, posts 24 are either placed in the ground or rest upon its surface. Tops of the posts preferably lie in a horizontal plane. The shell 46 is then placed on and firmly secured to the posts 24. As used herein, the term “posts” includes screw-type pilings which can be inserted into the ground with minimal disruption and without adverse environmental impact.

Preferably, the shell 46 includes rigid materials such as timber or steel for stability and support strength. Adequate shell strength and resistance to deflection by strong winds or rain is required to support the roof 22, the polygonal rear sub-assembly 12 and the pane arrangement 16 in the front sub-assembly 14.

The polygonal rear sub-assembly 12 preferably has a quadrilateral footprint. Alternative embodiments include a rectangular footprint. But other alternative geometries include hexagonal and octagonal footprints, for example.

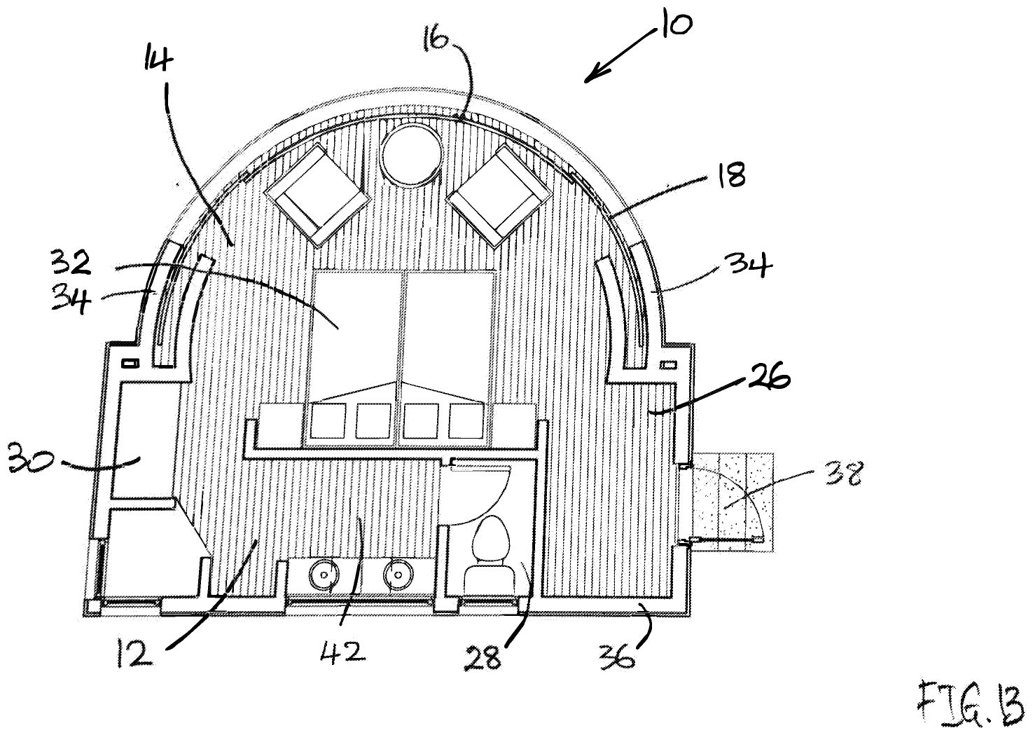

Other features of the rear sub-assembly 12 include facilities such as a closet 30 and a kitchenette (FIG. 13) in which can be housed for example technical equipment. Optionally, such equipment could be accommodated in the front sub-assembly 14.

The bowed pane arrangement 16 includes cooperating window frames that are slidably engaged by rails or tracks which are mounted in the floor 26 or ceiling 44 of a preferably semicircular section of the front sub-assembly 14. It will be appreciated that the bowed pane arrangement 16 may include one or multiple individual cooperating panes. Those panes may cover a 180-degree range, or more or less. At their arcuate ends, there is a curved front wall 34. On one curved front wall 34, there is a door or entry way.

Preferably the panes 16 are made of a transparent or semi translucent material that may or may not have photoelectrical properties that enable the panes to change color or tone in response to ambient light. Alternatively, such panes may include heating filaments that are connected to an electrical source. In another alternate embodiment, the panes 16 may be made of a material that has an opacity that changes in response to an electrical signal. Optionally, such features may be included in one or more skylights and may be operable independently or in sync with corresponding features in the panes 16.

In some embodiments, a protective sheeting or layer may be provided on at least one outside face of the pane arrangement 16. Optionally, a moisture protection layer may be provided on the interior surface of the pane arrangement 16.

Desirably, the roof 22 and the floor 26 are insulated with for example polyurethane insulation panels and/or an insulating wool.

A waterproofing material such as a suitable membrane is provided on an outside surface of the roof 22. Water pipes 50 can extend through the center of poles (not shown) that support the roof 22.

Covering the outside of the curved front wall 34 and the planar rear walls 36 is a conventional exterior surface treatment that is primarily selected for its visual appeal and protection from the outside elements.

In one embodiment, the pane arrangement 16 is a bowed transparent or semi translucent material. That material may have absorption characteristics that are influenced by ambient light. Such material may also be embodied in one or more of skylights.

The panes 16 are preferably shaped in a frusto-cylindrical manner: looking downwardly, such panes 16 may have a uniform radius of curvature. That radius may span about 0 to 180 degrees of arc. From a horizontal vantage point, the panes 16 are flat. The bowed panes 16 are supported by a frames that have upper and lower edges which are engaged by floor-mounted and ceiling-mounted tracks.

Edges of the panes 16 may overlap and be provided with sealing material for insulation. If desired, the pane arrangement may be provided with a security system, such as locks and/or an alarm.

Space utilization challenges are met by a combination of front curved and rear polygonal, preferably quadrilateral sub-assemblies 14,12. A closet 30 extends upwardly from the floor 26. Coverings 40 may be provided over the pane arrangement 16.

The bathroom 28 accommodates a commode and a shower (FIG. 13).

If desired, an air conditioning system may serve to meet heating and cooling needs. Optionally, a wood-burning stove may be provided. A water heater is preferably situated between in or behind the closet 30.

Preferably, the mobile dwelling system 10 is connected to utilities such as electricity, water and wastewater networks that are provided at an installation site such a mobile home park in which clusters of such dwelling units are situated.

### TABLE OF REFERENCE NUMBERS

| Reference No. | Component |
|---|---|
| 10 | mobile dwelling system |
| 12 | rear sub-assembly |
| 14 | front sub-assembly |
| 16 | pane arrangement |
| 18 | semicircular section |
| 20 | wall structure |
| 22 | roof |
| 24 | posts |
| 26 | floor |
| 28 | bathroom |
| 30 | closet |
| 32 | bedroom |
| 34 | curved front wall |
| 36 | planar rear wall |
| 38 | access entry way |
| 40 | coverings |
| 42 | washroom |
| 44 | ceiling |
| 46 | shell |
| 48 | pole |

What is claimed is:

1. A mobile modular dwelling system comprising:
a. a floor;
b. a front semicircular sub-assembly secured to the floor, the front semicircular sub-assembly including a pane arrangement;
c. a rear polygonal sub-assembly also secured to the floor and to the front semicircular sub-assembly so that in combination, the front and rear sub-assemblies provide a shelter in the face of prevailing wind and rain, regardless of the direction from which weather may originate, while offering an interior designer a wider latitude of furniture choices than does a semicircular footprint alone.

2. The mobile modular dwelling system of claim 1 wherein the front semicircular sub-assembly is detached from the rear quadrilateral sub-assembly before installation at a site.

3. The mobile modular dwelling system of claim 1 wherein the front semicircular sub-assembly is secured to the rear polygonal sub-assembly and to the foundation in situ.

4. The mobile modular dwelling system of claim 1 further including an array of utilities selected from the group consisting of window and wall coverings, a bed, a wash basin, a commode, a kitchenette, and a sauna or hot tub.

5. The mobile modular dwelling system of claim 1 wherein the front sub-assembly includes a plurality of sliding bowed panoramic panes made of transparent or translucent material or semi-translucent material that affords a wide range of view.

6. The mobile modular dwelling system of claim 1 wherein the rear sub-assembly mates with the front sub-assembly and has a footprint that accommodates a variety of convenience and utility features.

7. The mobile modular dwelling system of claim 1 wherein the rear polygonal sub-assembly has a footprint that is rectangular.

8. The mobile modular dwelling system of claim 1 wherein a wall structure rises from a floor to support a roof that overlies the front and rear sub-assemblies.

9. The mobile modular dwelling system of claim 1 wherein the floor is mounted on posts that are seated on or in ground that underlies a floor, the posts rising above the ground for distances necessary to support the floor in a generally horizontal plane, regardless of topography of underlying terrain.

10. The mobile modular dwelling system of claim 1, the front and rear sub-assemblies accommodate various utility spaces, including a bathroom, a closet, a kitchenette, and a bedroom.

11. The mobile modular dwelling system of claim 1 wherein the pane arrangement includes panes that can be positioned in opened or partly opened positions, thereby providing a sleeping area that can serve as a covered outdoor space that emulates an outdoor camping environment.

12. The mobile modular dwelling system of claim 1 wherein the pane arrangement includes panes that are supported by window frames that slidably extend vertically between a floor-mounted track and a ceiling-mounted track, thereby enabling interior front spaces to serve as an outdoor space if desired and when the panes are closed, the panes afford protection from an adverse outdoor environment while allowing the occupant(s) to commune with nature.

13. The mobile modular dwelling system of claim 12 wherein the pane arrangement is adapted to cooperate with a photoluminescent material so that its optical properties are adapted to be influenced by a source of electrical power.

14. The mobile modular dwelling system of claim 1 further including a roof that overlies the front and rear sub-assemblies.

15. The mobile modular dwelling system of claim 14 wherein the roof includes one or more skylights.

16. The mobile modular dwelling system of claim 15 wherein the one or more skylights include a material that is translucent or semi-translucent and has an optical property that is adapted to be influenced by electrical energy.

17. The mobile modular dwelling system of claim 1 wherein the front sub-assembly includes front curved walls between which the pane arrangement is positioned.

18. The mobile modular dwelling system of claim 17 further including a door defined within one or more of the front curved walls that provides an entryway.

19. A method of creating a mobile modular dwelling system comprising the steps of:
a. laying a floor;
b. securing a front semicircular sub-assembly to the floor, the front semicircular sub-assembly including a pane arrangement;
c. attaching a rear polygonal sub-assembly to the floor and to the front semicircular sub-assembly so that in combination, the front and rear sub-assemblies provide a shelter in the face of prevailing wind and rain, regardless of the direction from which weather may originate, while offering an interior designer a wider latitude of furniture choices than does a semicircular footprint alone.

20. A method of creating a mobile modular dwelling system comprising the steps of:
a. laying a floor;
b. attaching a rear rectangular sub-assembly to the floor;
c. securing a front semicircular sub-assembly to the floor and to the rear rectangular sub-assembly, thereby providing a firm shelter in the face of prevailing wind and rain, regardless of the direction from which weather may originate, while offering an interior designer a wider latitude of furniture choices than does a semicircular footprint alone.
